(19) United States
(12) Patent Application Publication
(10) Pub. No.: US 2016/0222481 A1
(43) Pub. Date: Aug. 4, 2016

(54) SYSTEM AND METHOD FOR ANNEALING OF AN ITEM, WHICH COMPRISES HEAT-SENSITIVE PARTS AND ANNEALED ITEM

(71) Applicant: BROEN A/S, Assens (DK)

(72) Inventors: Mads Lindegaard LILDHOLDT, Haarby (DK); Lars ANDERSEN, Hamdrup (DK); Lars Linaa JØRGENSEN, København S (DK); Peder MADSEN, Odense SV (DK)

(73) Assignee: BROEN A/S, Assens (DK)

(21) Appl. No.: 14/917,367

(22) PCT Filed: Sep. 8, 2014
(86) PCT No.: PCT/DK2014/050276

§ 371 Date: Mar. 8, 2016

(30) Foreign Application Priority Data
Sep. 9, 2013 (DK) PA 2013 70500

(51) Int. Cl. C21D 9/00; C21D 1/42; F16K 27/06; C21D 1/52; C22F 1/08; F16K 5/06; C21D 1/30; C21D 1/74

(52) U.S. Cl. CPC C21D 9/0068; C21D 1/30; C21D 1/42; C21D 1/74; C21D 9/0062; C21D 1/52; C22F 1/08; F16K 5/0657; F16K 27/067

(57) ABSTRACT

A method and a system for stress-relieving annealing one or more first parts of a workpiece, wherein a second part of the workpiece contains heat-sensitive parts. A cooling jacket is placed around the part of the workpiece surrounding heat-sensitive parts such that the part{s) to be annealed are located outside the cooling jacket. The first part(s) are then heated individually by induction up to the annealing temperature of the material in a first annealing zone in the system while simultaneously cooling the second part of the workpiece located in the cooling jacket. After annealing, the workpiece is cooled in a cooling zone, as annealing and cooling of the workpiece occurs under a protecting atmosphere. The annealed workpiece is, e.g., connection ends on a valve housing where the connection ends are shaped by plastic deformation after mounting valve seats, valve body etc. in the central part of the valve housing.

### BACKGROUND OF THE INVENTION

1. Field of the Invention

The present invention concerns a method for stress-relieving annealing one or more first parts of a workpiece, where a second part of the workpiece contains heat-sensitive parts as the annealing occurs by individual heating of the first part or parts of the workpiece up to the annealing temperature of the metal workpiece under a protecting atmosphere and under simultaneous cooling of the second part of the workpiece.

The present invention also concerns a system for stress-relieving annealing one or more first parts of a workpiece, wherein a second part of the workpiece contains heat-sensitive parts.

Finally, the invention concerns a workpiece which is stress-relievingly annealed according to the method or by the system according to the invention.

2. Description of Related Art

It is commonly known to make valves, e.g., ball valves, and thereby valve housings of several parts and then assemble these parts around a valve seat and a valve body. Such valves are typically made of brass or other copper-based alloys and are typically assembled by corresponding screw threads in respective parts, alternatively by means of bolts, e.g., by flange joints.

When speaking of a ball valve, the valve body is, as indicated by the name, spherical and with an outer size which is greater than the connecting openings in the valve housing. Such a valve therefore has a valve housing with an internal geometry in which valve seat and valve body are disposed. The valve housing is typically joined in the vicinity of the valve body as the latter requires the largest internal dimension. Such valves are typically made of cast workpieces which are formed and shaped by machining into the desired geometry. This shaping process is, however, rather cost-intensive for several reasons. The individual workpieces are to be cast and then handled and machined one by one in a suitable metal cutting unit. Since the workpieces are individually machined, the process is time-consuming, irrespective of application of modern and rapid processes.

In addition to the handling and machining of the cast workpieces prior to assembling around a valve seat and a valve body, the cost of the material also plays a significant role. Brass or other suitable alloys are expensive, entailing an appreciably higher cost than, e.g., common weldable carbon steel or stainless steel.

There is thus an expressed desire for making valves for, e.g., heating and cooling systems, for potable water and for other purposes in steel, e.g., carbon steel or stainless steel which is cheaper and which can be worked with modern production equipment directly from a plate piece or a tube piece by plastic deformation or similar by a faster and cheaper process than possible when casting and machining workpieces of brass.

Plastically deformed workpieces are normally to be stress-relieving annealed in order to restore the original properties. When a workpiece, e.g., the above mentioned valve housing, is shaped around heat-sensitive parts, e.g., a valve body, valve seat and packings made of other materials or other metals, e.g., copper, brass, rubber or plastic, which cannot stand up to the temperatures used by annealing, this method of restoring the properties of the material cannot be used, and annealing of the workpiece has to be dropped.

An example of annealing a steel workpiece is disclosed in U.S. Pat. No. 9,196,408. Here is described a method for heat treatment of a composite workpiece of austenitic steel such that one or more magnetic areas are formed in the workpiece. The heat treatment occurs under a protecting atmosphere and subsequent cooling, preferably by quenching under water, or by the protecting gas absorbing the heat from the workpiece. Cooling rings may possibly be applied on the workpiece.

It is therefore greatly desired to enable stress-relieving annealing of a part of a workpiece where another part of the workpiece contains heat-sensitive parts that cannot stand the high annealing temperatures.

### SUMMARY OF THE INVENTION

It is the object of the invention to indicate a solution to the above problems wherein it will be possible to perform stress-relieving annealing of a first part of a workpiece, where a second part of the workpiece contains parts that cannot stand heating or annealing.

These objects are achieved by a method for stress-relieving annealing of one or more first parts of a workpiece, wherein a second part of the workpiece contains heat-sensitive parts, at least including that a cooling jacket is placed around the part of the workpiece enclosing heat-sensitive parts such that the part or parts to be annealed are located outside the cooling jacket, wherein the first part or parts of the workpiece are heated up to the annealing temperature of the material under simultaneous cooling of the second part of the workpiece located in the cooling jacket, and where the workpiece is cooled, in that annealing as well as cooling occurs under a protecting atmosphere.

Hereby is achieved that it will be possible to produce a metal workpiece by shaping the workpiece and placing heat-sensitive parts in a part of the workpiece before stress-relieving annealing of a part of the workpiece, without the heat-sensitive parts of the second part of the workpiece being damaged by heat during the annealing operation. By the stress-relieving annealing the stresses arising in the metal during the deformation processes are removed, and the original properties of the material are restored. The heating preferably occurs by induction, as each first part of the workpiece is placed in a magnetic field that changes direction at a high frequency, contributing to ensure heating the metal workpiece to the annealing temperature. Alternatively, gas burners are used in that each first part of the workpiece is heated individually by one or more gas burners. If gas burners are used, combustion air or oxygen is supplied directly to the burners such that to the widest extent it is not mixed up with the protecting atmosphere. Heating by induction as described above has the great advantage that oxygen is not to be supplied, and that CO₂ is not generated during the heating. Since these gases can influence the corrosion properties of the metal, in the case of oxygen, and carbon content, in the case of CO₂, it is advantageous to avoid these gases as much as possible as the properties of the metal are thereby easier to control by the stress-relieving annealing operation with regard to carbon content and corrosion.

Cooling of the workpiece occurs preferably uniformly in the entire annealed area under the protective atmosphere. Cooling of the annealed parts of the workpiece can be effected by quenching, which is particularly suited for restoring the original material properties for austenitic types of steel, including stainless steels, or the cooling can occur gradually over a period of time, e.g., from 1 to 2 minutes to 2 hours, preferably in the course of 1 min-1 hr, including 2-10 min and particularly 2-6 min, for example for restoring material properties of other types of steel, including stainless steel and carbon steel. Since annealing and cooling is performed under the protecting atmosphere without the presence of oxygen, an oxide scale will not appear on the workpiece.

The temperature in the cooling zone is preferably of the same magnitude as the temperature of the part of the workpiece located in the cooling jacket as described below.

For example, valve housings of copper, carbon steel or stainless steel, including acid-proof stainless steel or similar materials, can thus be produced by mounting packings, valve seats, valve spindle and similar heat-sensitive parts in the central parts of the valve housing before shaping the connection ends. A valve housing which is only constituted by a single item formed in one piece without any kind of joining by welding, screws, bolts or similar joining methods can thereby be produced. Since the valve housing can be made from a tube piece, the invention is therefore very well suited in the case of ball valves, including common stop valves and through-flow valves. The invention may advantageously be used in shaping other types of valves, e.g., three-way valves or similar with more than two connection ends where the valve seat is located in a central part that has larger dimension and/or a shape different from the connection ends, and where it is thus advantageous to place valve body, valve seat and possible packings in the central part before shaping the connection ends. The method is thereby suited for shaping cheaper materials than brass and other copper-based alloys normally used in cast valve housings, as shaping by the method enables use of e.g., carbon steel or stainless steel or copper for making the valve housing, ensuring that the valve housing can be made of thin-walled materials, and that the greater part of cutting work and welding processes can be avoided by the making of the valve housings. However, the invention is not limited to the use of stress-relieving annealing of shaped valve housings, but may also be applied to stress-relieving annealing of a part of a metal workpiece of e.g., copper, carbon steel or stainless steel, including acid-proof stainless steel or similar materials, that may be stress-relievingly annealed with advantage, and where a second part contains heat-sensitive parts. Examples thereof can, e.g., be machine parts of steel that, e.g., contain ball bearings, plastic members, electronics or similar heat-sensitive parts that are mounted in the machine parts before annealing the workpieces.

In a variant of the invention, the temperature in the metal during the annealing will depend on the type of steel or steel alloy of which the workpiece is made, but will typically be in the range 700-1300° C., including preferably 800-1100° C., and including particularly 1000-1100° C., which will ensure that stainless steel types or acid-proof stainless steel types are heated to a temperature sufficient for annealing.

In a further variant of the invention, the cooling jacket keeps the second part of the workpiece at a temperature up to 150° C., including 50-150° C., and preferably 55-130° C., including particularly 60-80° C., ensuring that the temperature sensitive parts in the second part of the workpiece are not exposed to the high temperatures occurring by the annealing of the first parts of the workpiece. This will protect them from being destroyed during the annealing action, and thereby it becomes possible, e.g., to shape parts of the workpiece, e.g., a valve housing, including mounting the sensitive parts in the second part of the workpiece, before stress-relieving annealing of the first part or parts of the workpiece.

In a further variant, the cooling jacket is cooled before placing the workpiece in the cooling jacket. This will ensure that the heat-sensitive parts in the second part of the workpiece located in the cooling jacket are also cooled to some extent before the first parts of the workpieces are subjected to annealing. This will further contribute to protect these heat-sensitive parts against temperatures that will destroy the parts during annealing of the first parts of the workpiece.

The invention is therefore also suited for making valves which are peculiar in that the valve housing is made of a workpiece with tubular end parts, and that the valve body and one or more valve seats are mounted in the central part of the valve housing before the shaping of the connection ends, as the connection ends are then shaped by heating or annealing and subsequent shaping of the end parts of the tubular workpiece.

By applying this shaping of the valve housing it is allowed that shaping of the connection ends is effected after mounting valve seats, valve bodies and possible packings in the semi-finished valve housing. Besides, this will allow that the valve housing is made with substantially reduced material thickness, further contributing to substantially reduced production costs. The valve is thus well suited for use in connection with other thin-walled materials which at the time being gain a foothold in the industry and are increasingly applied to industrial solutions as well as to plumbing installations in residential buildings. There are innumerable advantages connected with thin walled pipes and fittings and the jointing methods are very simple whereby time-consuming and cost-raising work of threading, welding or soldering is avoided.

A variant of the method comprise subsequent cooling of the connection ends of the valve housing. Hereby is achieved that the annealing and the subsequent cooling of the metal, particularly types of steel, result in a stress-relieving annealing of the wall material of the valve housing, entailing that it is not necessary to perform a subsequent surface finishing of the valve housing, also resulting in a lower production cost of the finished product.

According to the invention, the annealing and the subsequent cooling is effected under application of a protective atmosphere as possible oxidation of the metal due to the presence of oxygen during annealing and cooling is avoided when using a protective atmosphere. The protective atmosphere includes, e.g., argon (Ar), helium (He), nitrogen (N₂), hydrogen (H₂) or a combination of one or more of these gases. A suitable protective gas for stainless steel is, e.g., FORMIER™ gas of Linde, which is based on nitrogen and contains a small amount of hydrogen, e.g., in an amount up to 5-10%. If the valve housing is made of copper, the inactive gas is preferably based on argon, nitrogen or helium, or mixtures thereof.

The invention further concerns a system for stress-relieving annealing one or more first parts of a workpiece, wherein a second part of the workpiece contains heat-sensitive parts. The second part of the workpiece is placed in a cooling jacket. The system includes a heating zone with means for individual heating of one or more first parts of a workpiece up to the annealing temperature of the material, a subsequent cooling zone for cooling the annealed first parts as the heating zone and the cooling zone are provided in a protective atmosphere. Hereby it becomes possible to anneal the first part of the workpiece simultaneously with the second part is kept cooled in the cooling jacket, ensuring that the heat-sensitive parts are not damaged during the annealing of the first part or parts of the workpiece. The two zones for annealing and cooling are preferably surrounded by a protective atmosphere in order to ensure that the metal is not exposed to oxygen and thereby oxidation of the metal and consequent rust formation during the annealing and the subsequent cooling. The protecting atmosphere in the two zones can, e.g., be formed in a tunnel where a first part of the tunnel constitutes the annealing zone and a second part of the tunnel constitutes the cooling zone.

In a variant of the system, it includes conveying means for conveying workpieces mounted in a cooling jacket through the heating zone and the cooling zone. This contributes to enable continuous feeding of workpieces mounted in cooling jackets such that the annealing and the subsequent cooling can be performed fully automatically in a production line.

In a further variant of the invention, the means for individual heating of one or more first parts of the workpiece include induction heating with an electromagnetic coil for disposition around a first part of the workpiece. This design enables uniform heating of the first parts of the workpiece along the entire periphery of the workpiece. Furthermore, this design enables the coils to be moved relative to the workpiece, e.g., in that the coils are each provided on a movable arm whereby the coils can be placed such that the first parts of the workpiece are disposed in the central opening of the coil when the workpiece is moved into the annealing zone of the system.

In a further variant of the system, the electromagnetic coils include means for keeping them cool, preventing that the metal in the coils, which most often is of copper, itself is heated to temperatures above the annealing temperature of the metal in the coil during induction heating of the workpieces.

In a further variant of the invention, the system includes means for cooling the cooling jacket, such as a preceding cooling zone for cooling the cooling jacket before placing the workpiece in the cooling jacket, e.g., in the form of a preceding cooling or freezing tunnel or cooling liquid connections for inlet and outlet of circulating cooling liquid to and from the cooling jacket. Water is very well suited as coolant since it is cheap and has large heat capacity and therefore is extremely well suited as coolant. In that the cooling jackets are cooled before the workpieces are placed in the cooling jackets, the cooled cooling jackets can ensure that the temperature in the second part of the workpieces is reduced before annealing of the first part of the workpiece. This will further contribute to prevent thermal damage on heat-sensitive parts in the second part of the workpiece.

The invention also concerns a workpiece with one or more first parts of a workpiece where a second part of the workpiece contains heat-sensitive parts which are stress-relievingly annealed according to the method and/or in a system according to the invention. In a variant, the workpiece is a valve including a valve housing with a central part and with one, two or more connection ends, the connection ends extending away from the central part, wherein internally of the central part there is arranged a valve body, the valve body arranged in a valve seat and connected to a valve spindle, the valve spindle arranged in a spindle guide stub on the valve housing, the valve housing made of a workpiece with tubular end parts which are shaped before the stress-relievingly annealing thereof, and that the valve body of the valve and one or more valve seats together with possible packings etc. are mounted in the central part of the valve housing before the shaping of the valve housing, in that the central part of the valve housing is first shaped by reducing the tube diameter of the tubular end parts, preferably by plastic deformation by dies and/or mandrels in one or more steps, and the connection ends are then shaped by plastic deformation of the tubular end parts, preferably by dies and/or mandrels in one or more steps. Hereby is achieved that it becomes possible to produce a valve housing where the diameter in the cross-section of the central part around valve body and a valve seat is greater than the diameter at the connection ends, for example when making a ball valve, e.g., a so-called full-flow ball valve, wherein the diameter in the aperture in the ball corresponds to the diameter in the connection ends and thereby also the diameter of the pipe system. This necessitates that the central part of the valve housing where ball and valve seats are located has greater diameter than the connection ends.

The central part of the valve housing contains components, e.g., valve housing, packings, etc. made of or including materials, e.g., resins such as Teflon® (PTFE), or elastomers such as, e.g., packings of ethylene propylene diene monomer (EPDM) which cannot stand the high temperatures occurring during the heat treatment or annealing of the connection ends. The central part of the valve housing is therefore kept cool during the annealing of the connection ends as the central part of the valve housing is placed in a cooling jacket which, e.g., is designed as cooling jaw. The cooling jacket is connected to a circulating coolant, including preferably water or other commonly known coolants. It is preferred that the temperature in the central part of the valve housing is about 50-150° C., preferably 60-80° C., ensuring that the heat-sensitive parts which are already mounted in the central part of the valve housing are not damaged during the heat treatment/annealing of the connection ends.

In a variant of the method, the valve spindle is mounted simultaneously with fastening the spindle guide stub on the workpiece with the tubular connection ends, implying fewer joints on the finished valve housing in that the spindle guide stub can be formed as a unit as an integrated end face on the spindle guide stub can keep the valve spindle in position in the spindle guide stub. When the threaded stub then is fastened on the central part of the workpiece with the tubular ends, it is avoided to form the spindle guide stub with a screw thread or a flange assembly for an end part holding the valve spindle in position in the spindle guide stub of the valve housing. Alternatively, the valve spindle can be mounted after mounting the spindle guide stub as the end of the valve stub therefore must comprise a threaded or flanged assembly or similar for an end part which is the only assembly in the valve housing.

The invention will now be explained below with reference to the accompanying drawings.

### BRIEF DESCRIPTION OF THE DRAWINGS

FIG. 1 shows a valve with a valve housing which is shaped and then stress-relievingly annealed according to the invention;

FIG. 2 shows a tubular workpiece with a spindle guide stub with valve spindle mounted;

FIG. 3 shows a valve housing disposed in a cooling jacket before stress-relieving annealing of the connection ends;

FIG. 4 shows means for induction heating of end parts of a valve housing with a mounted cooling jacket at the stress-relieving annealing; and

FIG. 5 shows a tunnel system whereby annealing and subsequent cooling can be performed under protecting atmosphere.

### DETAILED DESCRIPTION OF THE INVENTION

In the explanation of the figures, identical or corresponding elements will be provided with the same designations in different figures. Therefore, no explanation of all details will be given in connection with each single figure/embodiment.

In the following, the present invention will be explained in connection with stress-relieving annealing of the connection ends of a valve, e.g., a ball valve, where the central part of the valve housing contains heat-sensitive parts, including e.g., valve body, valve seats, packings and the like that are provided in the central part of the valve housing before shaping the connection ends. However, the invention is not limited to the use of stress-relieving annealing of shaped valve housings, but may also be applied to stress-relieving annealing of a part of a metal workpiece of e.g., copper, carbon steel or stainless steel, including acid-proof stainless steel, or similar materials, that may be stress-relievingly annealed with advantage, and where a second part contains heat-sensitive parts. Examples thereof can, e.g., be machine parts of steel that e.g., contain ball bearings, plastic members, electronics or similar sensitive parts that are mounted in the machine parts before annealing the workpieces.

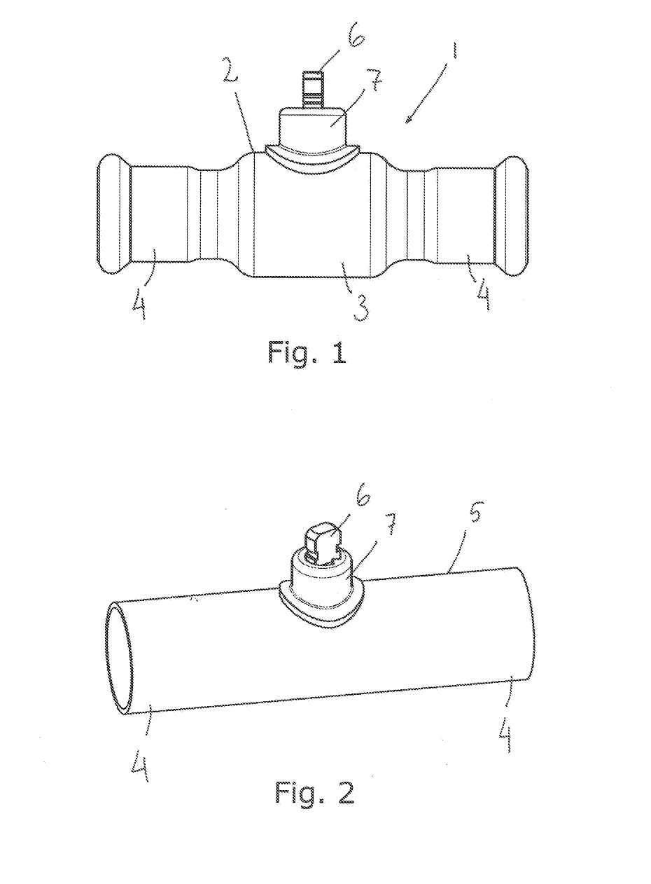

In FIG. 1, a valve 1 is shown with a valve housing 2 that has a central part 3 and at least two connection ends 4. The shaping of the valve housing 2 is effected from a tubular workpiece 5, see FIG. 2, where a spindle guide stub 7 and a valve spindle 6 are mounted in the spindle guide stub 7. Valve body and valve seats as well as packings (not shown) are then mounted inside the central part 3 of the tubular workpiece 5 in connection with the spindle guide stub and the valve spindle 6.

The valve housing 2 is made of steel, e.g., carbon steel or stainless steel, particularly acid-proof stainless steel, which is cheaper and which can be worked with modern production equipment directly from a plate piece or a tube piece by a faster and cheaper process than which, for example, is possible when casting and machining workpieces of brass.

The connection ends 4 of the valve housing 2 are here shown with a design adapted as so-called press-fittings. The shape of the connection ends 4 themselves is irrelevant to the invention and only an example of how these connection ends 4 can be made before stress-relieving annealing according to the invention.

At first, the two connection ends 4 are plastically deformed, preferably by axial and/or radial plastic deformation into a lesser internal cross-section, whereby the central part 3 of the valve housing attains an increased cross-section relative to the connection ends 4. The shape of the connection ends 4 is then adapted to the desired use by shaping with axial and/or radial plastic deformation with mandrels and/or dies into the final shape of the valve housing shown on FIG. 1.

This shaping of the metal causes formation of stresses that may entail corrosion of the metal, for example. Therefore it is normal to finish the surface of workpieces, e.g., by zincing or galvanizing the workpiece that has been plastically deformed, or alternatively to stress-relievingly anneal the workpiece.

According to the invention, the original properties of the material can be restored whereby this surface finishing can be avoided by stress-relieving annealing of the connection ends after shaping by plastic deformation.

According to the invention, this is preferably provided by induction heating in the form of annealing of the connection ends 4 of the valve housing 2. The heating by induction up to the annealing temperature of the material is effected by placing each first connection end 4 in a magnetic field that changes its direction at a high frequency as the central part of the valve housing is simultaneously kept at a lower temperature by means 8 for cooling the central part 3 of the valve housing 1.

Heating by induction as described above has the great advantage compared with gas burners that oxygen or combustion air is not to be supplied, and that no CO₂ is generated during the heating. Since these gases can influence the corrosion properties and carbon content, respectively, of the metal, it is advantageous to avoid these to the greatest possible extent as the properties of the metal are thereby approximately constant with regard to carbon content and corrosion.

After annealing, the connection ends 4 of the valve housing 2 are cooled. Hereby is achieved that the annealing and the subsequent cooling of the metal, particularly steel types, result in a stress-relieving annealing of the wall material of the valve housing, entailing that it is not necessary to perform a subsequent surface finishing of the valve housing.

The temperature in the metal during the annealing depends on which type of steel or steel alloy the valve housing is made, but will typically be in the range 700-1300° C., including preferably 800-1200° C., and in particular 1000-1100° C., as the annealing is, e.g., performed at about 1050° C. when using acid-proof stainless steel.

Cooling of the workpiece occurs preferably uniformly in the entire annealed area under the protective atmosphere in the cooling zone. Cooling of the annealed parts of the workpiece can be effected as quenching, which is particularly suited for restoring the original material properties of austenitic types of steel, including stainless steels, or the cooling can occur gradually over a period of time, e.g., up to 5 minutes, preferably in the course of 3 minutes or, e.g., up to two or one hour(s) for restoring the material properties of other types of carbon steel. The temperature in the cooling zone is preferably of the same magnitude as the temperature in the cooling jacket.

Annealing and the subsequent cooling occur under a protecting atmosphere in order to avoid oxidation of the metal. This also entails that no oxide scale appears on stainless steel after the annealing operation, and thereby removal of such oxide scale is also avoided. The protective atmosphere includes gasses such as argon (Ar), helium (He), nitrogen (N₂) or a combination of one or more of these gases. The protective gas can possibly contain small amounts of other gasses, including e.g., hydrogen (H₂). A suitable protective gas for stainless steel is e.g., the above mentioned FORMIER™ gas which is based on nitrogen and contains a small amount of hydrogen, e.g., in an amount up to 5-10%. If the valve housing is made of copper, the inactive gas is preferably based on argon, nitrogen or helium, or mixtures thereof.

Heating of the end parts 4 of the tubular workpiece 2′ for annealing is effected according to the invention by induction heating as this is possible by most steel alloys and copper. This method ensures rapid heating and is suited for fully automated production such that the entire process can occur fully automatically. This is preferably provided by passing an electromagnetic coil 16 around each of the end parts 4 after which the coils 16 are energized. The magnetic field hereby arising around and through the coils is constantly changing direction and will heat the connection ends 4, preferably until the annealing temperature for the metal or metal alloy is reached. The magnetic field preferably changes direction at a high frequency, contributing to ensure heating of the metal workpiece to the annealing temperature. After annealing the connection ends 4, the valve is subsequently cooled in the protecting atmosphere.

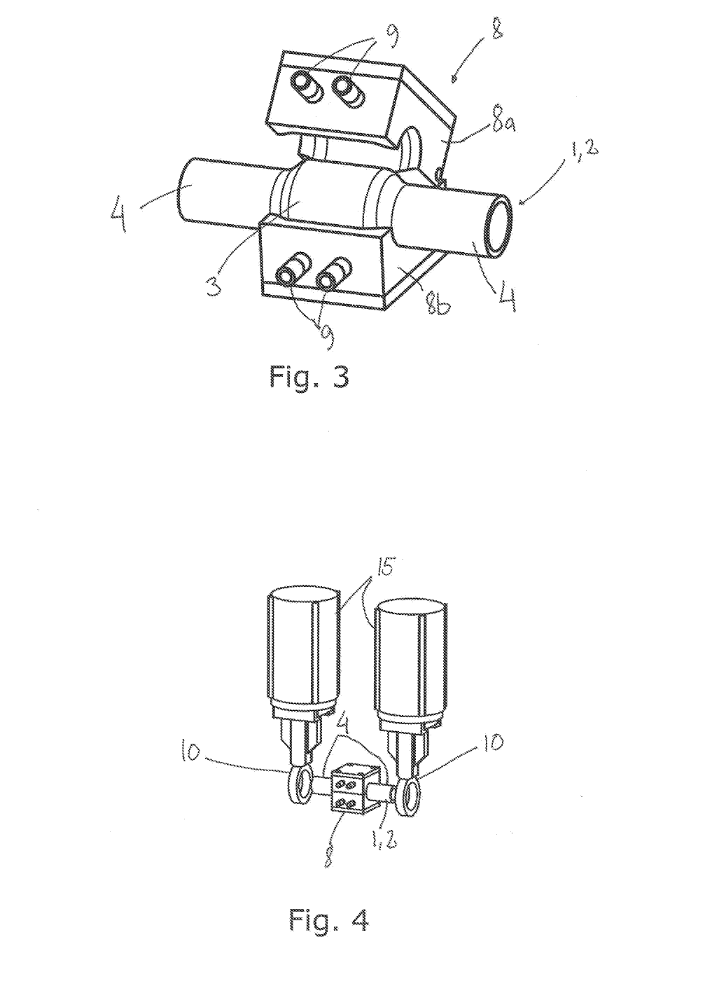

The central part of the valve housing contains components, e.g., valve housing, packings, etc. made of or including materials, e.g., resins such as Teflon® (PTFE), or elastomers such as, e.g., packings of ethylene propylene diene monomer (EPDM), etc., and which therefore cannot stand the high temperatures occurring during annealing of the connection ends. The central part 3 of the valve housing 2 is therefore cooled during the annealing as the central part 3 of the valve housing 2 is placed in a cooling jacket 8 which, e.g., is designed as cooling jaw 8, see FIG. 3. It is preferred that the temperature in the central part of the valve housing is about 50-150° C., preferably 55-130° C., preferably 60-80° C., ensuring that the heat-sensitive parts, i.e. spindle 6, valve body, valve seat, packings etc., which are already mounted in the central part 3 of the valve housing 2 are not damaged during the annealing of the connection ends 4.

The cooling jacket 8 is preferably made of metal, e.g., copper or similar, in the shown version designed as a cooling jaw with two interacting parts 8a, 8b which is clamped around the central part 3 of the valve housing 2 in which the heat-sensitive parts, e.g., valve body, valve seats and packings, are located. The internal surface of the cooling jaw 8 is designed with recesses that are designed such that the central part 3 of the valve housing 2 fits into the recesses, as the end parts 4 which are to be formed into connection ends 4 project outside the cooling jaw 8 shown on FIG. 3. Another shape of the cooling jacket 8 is possible as its shape is just to be adapted to the workpiece to be treated such that the cooling jacket 8 surrounds the part or parts of the workpiece that is/are to be protected against heat during annealing, and the parts to be annealed are disposed outside the cooling jacket 8.

In a variant of the invention, the cooling jacket 8 is cooled by moving the latter through a cooling zone (not shown in the Figure) prior to mounting the central part 3 of the valve 1 in the cooling jacket 8. The cooling zone is, e.g., a cooling or freezing tunnel. The cooling jacket is thereby cooled to a low temperature, e.g., below 10° C., such as −30-10° C. temperatures, including particularly −10-5° C., as it is possible thereby to keep the central part of the valve housing within the above mentioned temperature ranges. This is particularly due to the fact that the metal of the cooling jacket, in particular copper, readily absorbs and releases heat, and therefore is easily cooled as well. By providing the valve housing 2 in the cooled cooling jacket 8 before annealing the connection ends 4, a preceding cooling of the heat-sensitive parts of the central part 3 of the valve housing 2 is achieved as well, contributing to further counteracting any heat damage on heat-sensitive parts in the form of valve seat, valve body, packings, etc.

Alternatively, the cooling jacket 8 has connections 9 for inlet and outlet of a circulating coolant, including preferably water or other commonly known coolants. Water is very well suited since it is cheap and has large heat capacity and therefore is extremely well suited as coolant.

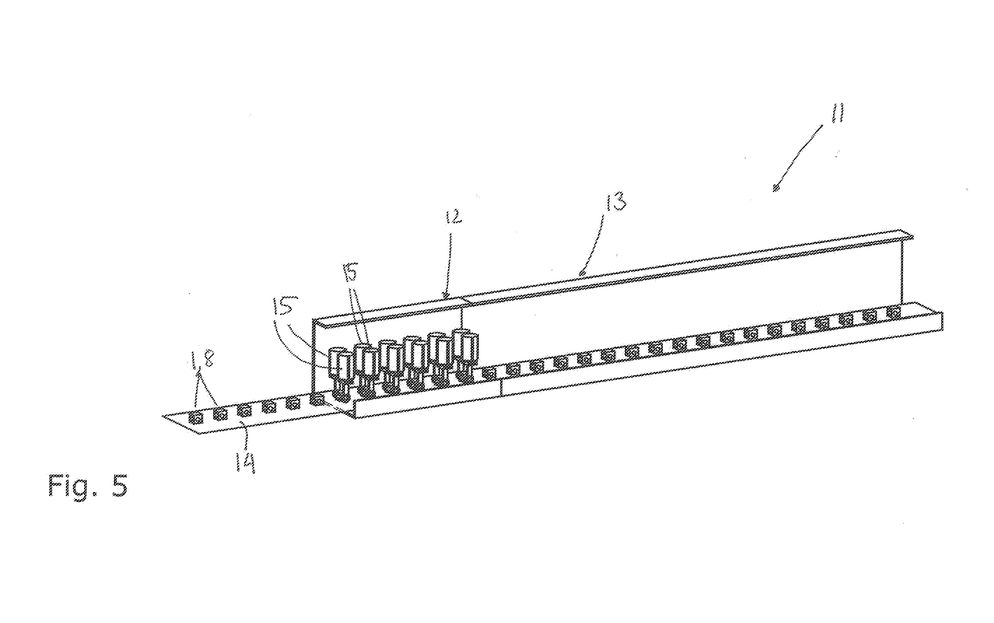

The invention is very well suited for full automation as shown on FIG. 5, as mounting of the valve housings 2 in the cooling jackets 8, disposition of the coils 10 around the connection ends 4 for induction heating for annealing and subsequent removal of the coils 10 can occur fully automatically, in that the annealing step 12 and the subsequent cooling 13 is effected under protective atmosphere which, e.g., can be provided in a tunnel 11 over a conveyor belt 14 on which the cooling jackets 8 with the valves 1 are placed. Automation of the production can e.g., be effected under application of robotics.

As mentioned, the ends of the valve housing are annealed by individual induction heating of each connection end 4. This is effected by an electromagnetic coil 10 for disposition around the connection end 4. The electromagnetic coil 10 is preferably annular as this will allow the connection end 4 to be heated uniformly along its entire circumference. If the system is used for stress-relieving annealing of other items with other shapes, the shape of the electromagnetic coil 10 can be adapted to the shape of the cross-section of the item, and the coil 10 can thus be oval or polygonal, such as triangular, quadratic, rectangular, pentagonal, hexagonal, etc.

The electromagnetic coils 10 preferably include means for cooling the coils to avoid overheating by the magnetic field.

The electromagnetic coils 10 are preferably each provided on a movable arm 15 by which the coils 10 can be placed around the connection ends 4 of the valve when the latter is moved into the annealing zone 12 in the system. These arms 15 are moved in a conventional way, e.g., as a robotic arm, by hydraulics or similar, and the movements are controlled in a conventional way, e.g., by a servomechanism which is, e.g., controlled by means of a preprogrammed processor.

1. A method for stress-relieving annealing at least one first part of a metal workpiece, where a second part of the workpiece contains heat-sensitive parts as the annealing occurs by individual heating of at least the first part of the workpiece up to the annealing temperature of the metal workpiece under a protecting atmosphere and under simultaneous cooling of the second part of the workpiece, wherein the method includes at least the following steps:
providing a cooling jacket around the second part of the workpiece surrounding heat-sensitive parts such that the at least one part to be annealed are located outside the cooling jacket;
individually heating of the at least first part of the workpiece up to the annealing temperature of the metal workpiece under simultaneous cooling of the second part of the workpiece located in the cooling jacket; and
cooling the workpiece;
wherein annealing as well as cooling of the workpiece is effected under a protecting atmosphere.

2. Method according to claim 1, wherein the annealing is effected at 700-1300° C.

3. Method according to claim 1, wherein the individual heating of each first part of the workpiece is effected by induction in that an electromagnetic coil is provided around the first part of the item.

4. Method according to claim 1, wherein the cooling jacket keeps the second part of the workpiece at a temperature up to 150° C.

5. Method according to claim 1, wherein the cooling jacket is cooled before placing the workpiece in the cooling jacket.

6. Method according to claim 1, wherein the protective atmosphere includes: argon (Ar), helium (He), nitrogen (N₂), hydrogen (H₂), any combination of any of argon (Ar), helium (He), nitrogen (N₂), hydrogen (H₂).

7. Method according to claim 1, wherein the valve is a ball valve.

8. A system for stress-relieving annealing at least one first part of a workpiece, wherein a second part of the workpiece contains heat-sensitive parts, wherein the second part of the workpiece is provided in a cooling jacket, and that the system includes
a heating zone with means for individual heating of at least one first part of a workpiece up to the annealing temperature of the material;
a subsequent cooling zone for cooling the annealed first parts, as the heating zone as well as the cooling zone are provided in a protecting atmosphere.

9. System according to claim 8, wherein the system includes conveying means for conveying workpieces located in a cooling jacket through the heating zone and the cooling zone.

10. System according to claim 8, wherein the means for individual heating of each first part of the workpiece include induction heating with an electromagnetic coil for disposition around each first part of the workpiece.

11. System according to claim 8, wherein the system further includes means for cooling the cooling jacket, such as a preceding cooling zone for cooling the cooling jacket before placing the workpiece in the cooling jacket.

12. A workpiece with at least one first part of a workpiece, wherein a second part of the workpiece contains heat-sensitive parts, wherein the work piece has been annealed according to the method according to claim 1.

13. Workpiece according to claim 12, wherein the workpiece is a valve including a valve housing with a central part and with at least one connection end, the connection end extending away from the central part, wherein internally of the central part there is arranged a valve body, the valve body arranged in a valve seat and connected to a valve spindle, the valve spindle arranged in a spindle guide stub on the valve housing, the valve housing made of a workpiece with tubular end parts, and wherein the valve body and at least one valve seat is mounted in the central part of the valve housing before the shaping of the valve housing, wherein the central part of the valve housing is first shaped by reducing the tube diameter of the tubular end parts, by plastic deformation in at least one step, and the at least one connection end is then shaped by plastic deformation of the tubular end parts in at least one step.

14. Workpiece according to claim 12, wherein the valve is a ball valve.

15. Method according to claim 1, wherein the individual heating of each first part of the workpiece is effected by at least one gas burner provided around the first art of the item.

16. System according to claim 8, wherein the system further includes means for cooling the cooling jacket.

17. System according to claim 16, wherein said means for cooling comprises cooling liquid connections for inlet and outlet of cooling liquid circulating to and from the cooling jacket.
